(19) United States
(12) Patent Application Publication
(10) Pub. No.: US 2026/0329952 A1
(43) Pub. Date: Oct. 22, 2026

(54) AUTOMATED SYSTEM FOR ESTIMATING CONTENT REACH AND REVIEWING PERSONALIZED CONTENT

(71) Applicant: Adobe Inc., San Jose, CA (US)

(72) Inventors: Suofei WU, Fremont, CA (US); Jun HE, Fremont, CA (US)

(21) Appl. No.: 19/186,401

(22) Filed: Apr. 22, 2025

(51) Int. Cl. G06F 16/9535; G06F 16/9538

(52) U.S. Cl. CPC G06F 16/9535; G06F 16/9538

(57) ABSTRACT

Some aspects relate to technologies providing a framework for estimating content reach and reviewing personalized content. In accordance with some aspects, a user requests to estimate the reach of content variations of code-based content to target profiles. A background thread is initiated to display progressive results and representative content variations for the user to review. In order to determine the estimated reach, an abstract syntax tree is determined from the content and the target profiles are sampled. The number of profiles per content variation is determined based on the tree evaluation state of each of the sampled profiles. The estimated reach of each content variation is determined using an estimation technique based on the number of profiles per content variation and the total number of profiles. The estimated reach of each content variation is refined by increasing the sample size when sampling the target profiles.

### BACKGROUND

The current process of reviewing personalized content campaigns is time-consuming and complex, which places a heavy burden on content designers. To ensure that personalized content campaigns display accurately, content designers must manually create test profiles and apply the personalized content to the test profile. In this regard, each variation in the content must be manually checked by the content designer to ensure it appears correctly to different audience segments.

### SUMMARY

Some aspects of the present technology relate to, among other things, an automated system for estimating content reach and reviewing personalized content. In some aspects, the technology includes systems and methods to address the time-consuming, complex and computationally expensive process of manually creating test profiles and applying personalized content to these profiles to ensure accurate display across different audience segments. In various embodiments, a user submits a request to estimate the reach of content variations of content to a selected set of target profiles. A background thread is initiated to display progressive results regarding the estimated reach of each content variation of the code-based content to the target profiles and representative content variations for the user to review. In order to determine the progressive results regarding the estimated reach of each content variation to the target profiles, an abstract syntax tree (AST) is determined from condition statements of the content. Profiles are sampled from the target set of profiles, the sampled set of profiles are filtered based on required attributes of condition branches of the AST, and the tree evaluation state of each profile is determined with respect to the AST without rendering the content. Each unique tree evaluation corresponds to a content variation of the content. The estimated reach of each content variation for the entire target set of profiles is determined using an estimation technique, such as a Horvitz-Thompson estimator, based on the number of profiles per content variation and the total number of profiles. The initial results are displayed to the user, and the backend thread refines the results by increasing the sample size when sampling the target profiles. In various embodiments, representative content variations are determined for each content variation based on a corresponding representative profile. Sensitive data in each representative content variation is masked, ensuring privacy during testing. The progressive results, the condition branches of the AST, and the representative content variations are displayed to the user, thereby allowing the user to review and verify the content variations while the progressive results of the estimated reach of each content variation are being refined in parallel via the backend thread.

This summary is provided to introduce a selection of concepts in a simplified form that are further described below in the Detailed Description. This summary is not intended to identify key features or essential features of the claimed subject matter, nor is it intended to be used as an aid in determining the scope of the claimed subject matter.

### BRIEF DESCRIPTION OF THE DRAWINGS

The present technology is described in detail below with reference to the attached drawing figures, wherein:

FIG. 1 is a block diagram illustrating an exemplary system in accordance with some implementations of the present disclosure;

FIG. 2 is a block diagram illustrating an example subsystem for determining an abstract syntax tree of condition branches and condition branch attributes, in accordance with some implementations of the present disclosure;

FIG. 3 is a block diagram illustrating an example subsystem for sampling profiles, in accordance with some implementations of the present disclosure;

FIG. 4 is a block diagram illustrating an example subsystem for compiling the tree evaluation state of profiles, in accordance with some implementations of the present disclosure;

FIG. 5 is a block diagram illustrating an example subsystem for estimating the reach of content variations, in accordance with some implementations of the present disclosure;

FIG. 6 is a block diagram illustrating an example subsystem for causing rendering of a representative content variations, in accordance with some implementations of the present disclosure;

FIG. 7 is a flow diagram illustrating a method for estimating content reach and reviewing personalized content, in accordance with some implementations of the present disclosure;

FIG. 8 is a flow diagram illustrating a method for initiating a backend thread to estimate content reach, in accordance with some implementations of the present disclosure; and

FIG. 9 is a block diagram of an exemplary computing environment suitable for use in implementations of the present disclosure.

### DETAILED DESCRIPTION

### Definitions

Various terms are used throughout this description. Definitions of some terms are included below to provide a clearer understanding of the ideas disclosed herein.

As used herein, “computer code” or “code” is a set of instructions written in a programming language that a computer can understand and execute. For example, the computer code instructs the computer how to perform specific tasks, such as calculations, data processing, or controlling hardware devices. Examples of programming languages, include HyperText Markup Language (HTML), Python, Java, C++, and/or the like. “Code-based content” refers to content, such as electronic mail (email) advertisements, that include computer code to personalize the content for a user, such as a customer. For example, a website might display personalized product suggestions based on a user's browsing history, or an email campaign might include personalized emails based on the customer's demographics or customized offers based on past purchases.

As used herein, “HTML email” refers to an email format that includes a set of instructions written in HTML to create visually appealing and interactive messages. For example, HTML emails can include various elements such as conditions, images, links, tables, and styled text, allowing for a more engaging and professional presentation.

As used herein, “conditions” are logical statements that control the flow of execution within computer code, and are used to make decisions based on whether certain criteria are met. Examples of condition statements include if statements, else if statements, else statements, unless statements, with statements, let statements, and/or the like.

As used herein, “condition branches” or “branches” are the different paths that the execution of a program can take based on certain conditions. For example, when a condition is met corresponding to a particular branch, the program executes a specific block of code.

As used herein, an “abstract syntax tree (AST),” also referred to herein as a “condition tree structure,” is a representation of the abstract syntactic structure of source code written in a programming language. The AST includes nodes connected by edges, where each node represents an element or entity, and the edges represent relationships between the nodes. For example, each node represents a condition, and the edges represent the different paths the program can take based on those conditions (e.g., a condition branch). As an example, in an if-else statement, the root node might represent the initial condition, and the edges would represent the code executed if the condition is true or false.

As used herein, “a tree evaluation state” is a data representation indicating the outcomes of condition branches of an AST. For example, each outcome of each condition branch can correspond to a true or false value. For example, for an AST with three condition branches and the outcomes of the three conditions branches are [true, false, true], the tree evaluation state can be described as [1, 0, 1]. In various embodiments, each tree evaluation state corresponds to different possible content variations of code-based content.

As used herein, a “backend thread” is a separate thread of execution that runs in the background, such as on the server side of an application. For example, by running a background thread, multiple tasks can be executed concurrently, such as processing data, handling network requests, or performing complex calculations without blocking the main thread.

As used herein, “progressive results” are incremental updates that a background thread provides while the background thread is still running. For example, progressive results allow the main application to display intermediate results to the user while the backend thread is still running to decrease latency in providing results and improve the user experience.

As used herein, a “schema” is a structured framework that defines the organization and format of customer data within a content reach estimation and review system. A schema can set forth the particular attribute, also referred to as “fields,” that are used to store and retrieve data relevant to customer profiles. An “attribute” is a specific identifier specified by a schema. For example, a schema might define attributes such as “first name”, “last name”, “age, “gender,” “email address,” “ID,” and/or any attributes relevant to customer profiles. In this regard, attribute values for a particular customer profile would include the particular customer's first name, last name, age, etc. A “customer profile” refers to the particular attribute values in the schema for a particular customer based on the customer data for the particular customer.

As used herein, “customer data” refers to any data regarding a customer or customers, such data regarding interaction between a customer and an advertisement on a customer device. Customer data within a dataset may include, by way of example and not limitation, data that is sensed or determined from one or more sensors, such as location information of mobile device(s), smartphone data (such as phone state, charging data, date/time, or other information derived from a smartphone), activity information (for example: app usage; online activity; searches; browsing certain types of webpages; listening to music; taking pictures; voice data such as automatic speech recognition; activity logs; communications data including calls, texts, instant messages, and emails; website posts; other user data associated with communication events) including activity that occurs over more than one device, user history, session logs, application data, contacts data, calendar and schedule data, notification data, social network data, news (including popular or trending items on search engines or social networks), online gaming data, ecommerce activity, including customer journey data, sports data, health data, customer demographics, customer's geographical location, economic status, customer gender, customer age, or any other relevant demographic data collected regarding the customer, and nearly any other source of data that may be used to identify the customer.

### Overview

As described above, the current process of reviewing personalized content campaigns is time-consuming and complex, requiring content designers, such as marketers, to manually create test profiles and apply personalized content to each profile. This manual approach is labor-intensive and prone to human error, leading to potential gaps in coverage and incorrect content display for specific user segments. For instance, conditional blocks or personalized elements may only appear under certain profile conditions, and ensuring that all these variations are covered is challenging when done manually. A single oversight could mean that a segment of the audience receives irrelevant or improperly formatted content, which could impact engagement rates and even damage the brand's reputation. As a result, content designers will often create a significant number of redundant or unnecessary test profiles when reviewing personalized content campaigns to test various conditions of the personalized content campaign. Furthermore, content designers will not know whether there is an issue with a particular content variation reaching an intended target audience segment until a significant amount of time is spent reviewing the personalized content campaign or the personalized content campaign is running. Consequently, content designers will spend unnecessary additional time reviewing or implementing a version of the personalized content campaign that includes irrelevant or improperly formatted content.

Each time the content designer compiles and renders the personalized content for each test profile, computing and network resources are consumed. Conventional approaches often lead content designers to create redundant or unnecessary test profiles to test various conditions of the personalized content campaign to ensure that a segment of the audience does not receive irrelevant or improperly formatted content. Conventional approaches result in excessive use of computing and network resources, as the system must compile and render content variations for the redundant or unnecessary test profiles. The unnecessary compiling and rendering of content variations for the redundant or unnecessary test profiles significantly increases the computational load, leading to higher latency and slower processing times, as the system is burdened with unnecessary tasks. Additionally, the unnecessary transmission of large amounts of data strains network bandwidth, causing delays and potential bottlenecks in the network infrastructure. Consequently, the increased computational and network demands due to unnecessary compiling and rendering of content variations for the redundant or unnecessary test profiles increase computational costs and decrease the overall computational efficiency of the content proofing process.

Conventional approaches often cause content designers to spend unnecessary additional time reviewing or implementing a version of the personalized content campaign that includes irrelevant or improperly formatted content, thereby consuming unnecessary computing and network resources. When issues arise in a personalized content campaign, the faster the issues are detected, the quicker the content designer can resolve the issues with the current version of the personalized marketing campaign and limit any additional computing and network resources expended on reviewing or implementing the current version of the personalized marketing campaign. Thus, delays to the process of providing results that can indicate issues with the personalized marketing campaign (e.g., progressive results, representative content variations, condition branches of the AST, and/or the like) can lead to prolonged consumption of computing and networking resources expended on reviewing or implementing the version of the personalized marketing campaign that includes irrelevant or improperly formatted content. As a result, an increase in the time to provide results regarding the current version of the personalized marketing campaign can increase the computational load and network bandwidth usage required for the content proofing process.

Aspects of the technology described herein address the problems of conventional systems for reviewing personalized content by providing a content reach estimation and review system that efficiently and effectively estimates the content reach of content variations of code-based content and provides representative content variations for review. In operation, a user submits a request to estimate the reach of content variations of code-based content, such as an HTML email, to a selected set of target profiles. A background thread is initiated to display progressive results regarding the estimated reach of each content variation of the code-based content to the target profiles and representative content variations for the user to review. By providing progressive results that indicate issues with the personalized marketing campaign earlier than the final results of the estimation process, the user can identify issues with a version of a personalized marketing campaign earlier in the content proofing process, thereby increasing computational and network efficiency for the content proofing process.

In order to determine the progressive results regarding the estimated reach of each content variation to the target profiles, an AST is determined from condition statements of code-based content. Profiles are sampled from the target set of profiles, the sampled set of profiles are filtered based on required attributes of condition branches of the AST, and the tree evaluation state of each profile is determined with respect to the AST without compiling or rendering the content for each profile. By only compiling the tree evaluation state of each profile without compiling or rendering the actual content variation for each profile, unnecessary compiling and rendering of content variations is reduced, thereby increasing computational and network efficiency for the content proofing process.

Each unique tree evaluation corresponds to a content variation of the code-based content. In this regard, the number of profiles per content variation is determined based on the tree evaluation state of each profile of the sample set of profiles. The estimated reach of each content variation for the entire target set of profiles is determined using an estimation technique, such as a Horvitz-Thompson estimator, based on the number of profiles per content variation and the total number of profiles. The initial results are displayed to the user and the backend thread refines the results by increasing the sample size when sampling the target profiles. The refined results are then provided to the user.

In various embodiments, representative content variations are determined for each content variation based on a corresponding representative profile. By only compiling and rendering a corresponding representative content variation for each unique content variation (e.g., each unique tree evaluation state), unnecessary compiling and rendering of content variations for redundant or unnecessary test profiles is reduced, thereby increasing computational and network efficiency for the content proofing process. Sensitive data in each representative content variation is masked, ensuring privacy during review by the user. The progressive results, the condition branches of the AST, and the representative content variations are displayed to the user, thereby allowing the user to review and verify the content variations while the progressive results are being refined in parallel via the backend thread. By providing results that can indicate issues with the personalized marketing campaign (e.g., progressive results, representative content variations, and/or condition branches of the AST) earlier than the final results of the estimation process, the user can identify issues with a version of a personalized marketing campaign earlier in the content proofing process, thereby increasing computational and network efficiency for the content proofing process.

Aspects of the technology described herein provide a number of improvements over existing technologies. For example, the steps of the aforementioned process to estimate the content reach of content variations of code-based content and provide representative content variations for review can be performed automatically and with no human intervention to (1) reduce human error and inefficiency of identifying issues with a personalized marketing campaign, (2) reduce the number of unnecessary or redundant test profiles that must be compiled and rendered during the content proofing process, and (3) reduce unnecessary additional time reviewing or implementing a version of the personalized content campaign that includes irrelevant or improperly formatted content. A user can select content and target set of profiles, and the steps of initiating a backend thread, determining the AST, sampling the profiles, determining the number of profiles per tree evaluation state, determining the estimated reach of each content variation for the target set of profiles, updating the progressive results, determining representative content variations, causing display of the progressive results, causing display of the representative content variations, and causing display of the condition branches of the AST can be performed automatically, as described herein, with the output of one operation being used as the input of a subsequent operation. The technology described herein results in less manual operations that are required to estimate the content reach of content variations of code-based content and provide representative content variations for review, which results in a more efficient use of computing and network resources due to the decrease in the number of input/output operations and data communicated over a computer network (e.g., resulting in higher throughput, reduced latency and less packet generation costs as fewer packets are sent over a network). Further, the progressive results, representative content variations, and/or condition branches of the AST displayed to the end user using the technology described herein results in a more efficient use of computing and network resources by reducing the amount of time required for a user to detect issues with a personalized marketing campaign to limit any additional computing and network resources expended on reviewing the version of the personalized marketing campaign results before resolving the issues.

Further, in various embodiments, compiling the tree evaluation state of each profile without compiling the content variation for each profile or rendering the content variation for each profile results in a more efficient use of computing and network resources due to the decrease in the number of input/output operations and data communicated over a computer network. For example, by only compiling the tree evaluation state of each profile without compiling the content variation for each profile or rendering the content variation for each profile, unnecessary compiling and rendering of content variations for redundant or unnecessary profiles are reduced, thereby decreasing the computational and network demands and computational costs and increasing the overall computational efficiency of the content proofing process. Similarly, in various embodiments, by only rendering representative content variations of unique tree evaluation states, unnecessary compiling and rendering of content variations for redundant or unnecessary profiles are reduced, thereby decreasing the computational and network demands and computational costs and increasing the overall computational efficiency of the content proofing process.

Even further, in various embodiments, by providing the progressive results to the end user (e.g., by running the estimation process as a background thread in parallel with providing the progressive results), the technology described herein can provide real-time feedback and progressively improve the accuracy of the estimations while reducing latency to provide initial estimations to the user to improve computational and network efficiency and improve the user experience. For instance, by providing results, such as progressive results, content variations, and/or condition branches of the AST, that can indicate issues with the personalized marketing campaign earlier than the final results of the estimation process, the user can limit any additional computing and network resources expended on the estimation process or expended on reviewing the current version of the personalized marketing campaign at an earlier point in time, thereby increasing computational and network efficiency. Further, in certain embodiments, the absence of a backend thread to run the estimation process in parallel with providing the progressive results would result in a higher computational load on the main thread, potentially causing performance issues and further straining computing and network resources, which could lead to slower processing times, increased computational costs, and a less responsive user experience.

### Example Systems for Estimating Content Reach and Reviewing Personalized Content

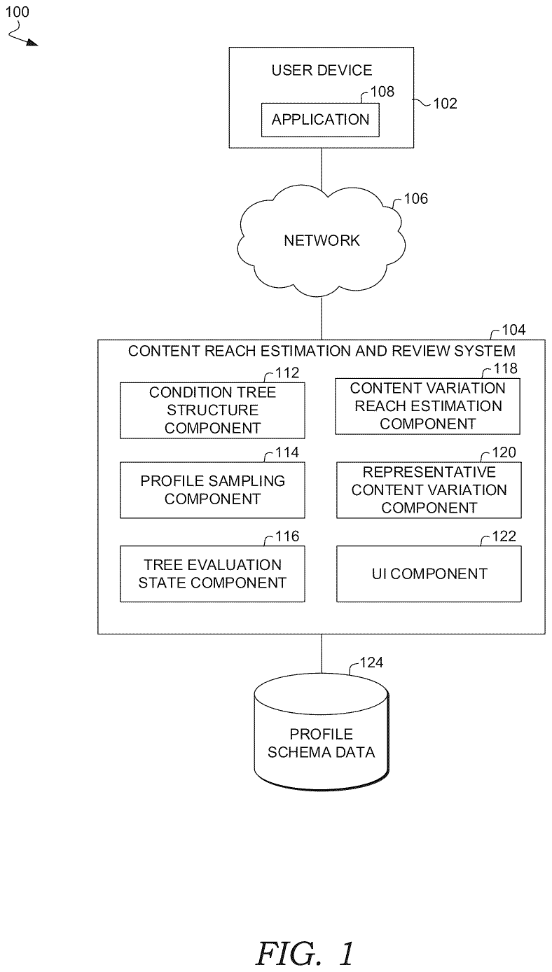

With reference now to the drawings, FIG. 1 is a block diagram illustrating an exemplary system 100 for automated estimation of content reach and rendering of content variations for reviewing personalized content campaigns in accordance with implementations of the present disclosure. It should be understood that this and other arrangements described herein are set forth only as examples. Other arrangements and elements (e.g., machines, interfaces, functions, orders, and groupings of functions, etc.) can be used in addition to or instead of those shown, and some elements may be omitted altogether. Further, many of the elements described herein are functional entities that may be implemented as discrete or distributed components or in conjunction with other components, and in any suitable combination and location. Various functions described herein as being performed by one or more entities may be carried out by hardware, firmware, and/or software. For instance, various functions may be carried out by a processor executing instructions stored in memory.

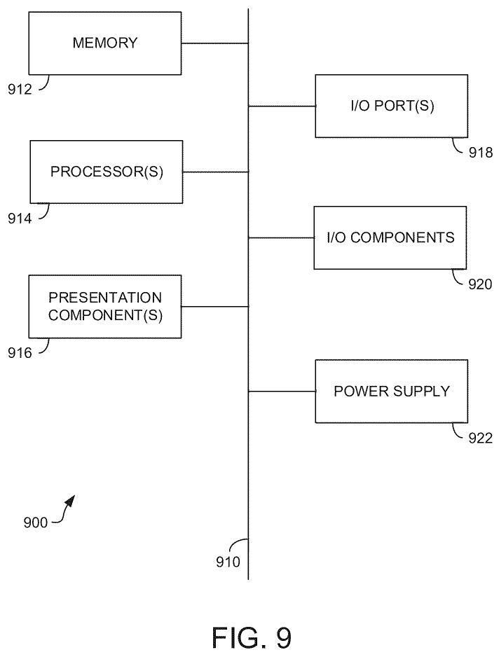

The system 100 is an example of a suitable architecture for implementing certain aspects of the present disclosure. Among other components not shown, the system 100 includes a user device 102 and a content reach estimation and review system 104. Each of the user device 102 and the content reach estimation and review system 104 shown in FIG. 1 can comprise one or more computer devices, such as the computing device 900 of FIG. 9, discussed below. As shown in FIG. 1, the user device 102 and the content reach estimation and review system 104 can communicate via a network 106, which may include, without limitation, one or more local area networks (LANs) and/or wide area networks (WANs). Such networking environments are commonplace in offices, enterprise-wide computer networks, intranets, and the Internet. It should be understood that any number of user devices and servers may be employed within the system 100 within the scope of the present technology. Each may comprise a single device or multiple devices cooperating in a distributed environment. For instance, the content reach estimation and review system 104 could be provided by multiple server devices collectively providing the functionality of the content reach estimation and review system 104 as described herein. Additionally, other components not shown may also be included within the network environment.

The user device 102 can be a client device on the client-side of the system 100, while the content reach estimation and review system 104 can be on the server-side of the system 100. The content reach estimation and review system 104 can comprise server-side software designed to work in conjunction with client-side software on the user device 102 so as to implement any combination of the features and functionalities discussed in the present disclosure. For instance, the user device 102 can include an application 108 for interacting with the content reach estimation and review system 104. The application 108 can be, for instance, a web browser or a dedicated application for providing functions, such as those described herein. This division of the system 100 is provided to illustrate one example of a suitable environment, and there is no requirement for each implementation that any combination of the user device 102 and the content reach estimation and review system 104 remain as separate entities. While the system 100 illustrates a configuration in a networked environment with a separate user device and content reach estimation and review system, it should be understood that other configurations can be employed in which aspects of the various components are combined. For instance, in some aspects, aspects of the content reach estimation and review system 104 can be implemented in part or in whole by the user device 102.

The user device 102 can comprise any type of computing device capable of use by a user. For example, in one aspect, the user device 102 may be the type of computing device 900 described in relation to FIG. 9 herein. By way of example and not limitation, the user device 102 can be embodied as a personal computer (PC), a laptop computer, a mobile or mobile device, a smartphone, a tablet computer, a smart watch, a wearable computer, a personal digital assistant (PDA), an MP3 player, global positioning system (GPS) or device, video player, handheld communications device, gaming device or system, entertainment system, vehicle computer system, embedded system controller, remote control, appliance, consumer electronic device, a workstation, or any combination of these delineated devices, or any other suitable device. A user can be associated with the user device 102 and can interact with the content reach estimation and review system 104 via the user device 102.

In various embodiments, content reach estimation and review system 104 is implemented to estimate the reach of personalized content variations by analyzing code-based content to estimate the number of customer profiles that interact with each content variation of the code-based content. In various embodiments, content reach estimation and review system 104 can be accessed via an application programming interface (API). In various embodiments, content reach estimation and review system 104, or components thereof, is configured as a backend thread to run the estimation process in parallel in order to refine the results while the API handles user interactions, such as by providing progressive results to the user via application 108 on user device 102. By running the content reach estimation and review system 104, or components thereof, as a background thread, the content reach estimation and review system 104 can provide real-time feedback and progressively improve the accuracy of its estimations.

For example, a marketer can initiate a request to the content reach estimation and review system 104 via an API during the proofing process for a personalized marketing campaign based on code-based content, such as an HTML email. The content reach estimation and review system 104 calculates the estimated reach for each content variation of the code-based content, providing marketers with insights into the number of customer profiles that each content variation of the code-based content will reach. For instance, the code-based content may include a condition to send a particular content variation to the male audience of the customer profiles and a different content variation to the female audience of the customer profiles distribution. The content reach estimation and review system 104 estimates the number of customer profiles that each content variation will reach, renders representative content variations for a representative customer profile for each content variation so that the marketer can review each content variation, and refines the estimation in the backend thread in parallel with communicating the current estimation and representative content variations to the user device 102 for display. The marketer is able to review each content variation to ensure that the personalized content is accurately rendered for different audience segments and reaches the intended target audience based on the estimated reach of each content variation, thereby improving the overall effectiveness of the marketing campaign.

As shown in FIG. 1, the content reach estimation and review system 104 comprises a condition tree structure component 112, a profile sampling component 114, a tree evaluation state component 116, content variation reach estimation component 118, a representative content variation component 120, and/or a user interface (UI) component 122. The components/modules of the content reach estimation and review system 104 may be in addition to other components/modules that provide further additional functions beyond the features described herein. The content reach estimation and review system 104 can be implemented using one or more server devices, one or more platforms with corresponding application programming interfaces, cloud infrastructure, and the like. While the content reach estimation and review system 104 is shown separate from the user device 102 in the configuration of FIG. 1, it should be understood that in other configurations, some or all of the functions of the content reach estimation and review system 104 can be provided on the user device 102. Additionally, in some configurations, one or more of the components/modules of the content reach estimation and review system 104 shown in FIG. 1 can be provided by the user device 102 and/or another location not shown in FIG. 1. The components/modules can be provided by a single entity or multiple entities.

In some aspects, the functions performed by components/modules of the content reach estimation and review system 104 are associated with one or more applications, services, or routines. In particular, such applications, services, or routines may operate on one or more user devices, servers, may be distributed across one or more user devices and servers, or be implemented in the cloud. Moreover, in some aspects, these components/modules of the content reach estimation and review system 104 may be distributed across a network, including one or more servers and client devices, in the cloud, and/or may reside on a user device. Moreover, these components/modules, functions performed by these components/modules, or services carried out by these components/modules can be implemented at appropriate abstraction layer(s) such as the operating system layer, application layer, hardware layer, etc., of the computing system(s). Alternatively, or in addition, the functionality of these components/modules and/or the aspects of the technology described herein can be performed, at least in part, by one or more hardware logic components. For example, and without limitation, illustrative types of hardware logic components that can be used include Field-programmable Gate Arrays (FPGAs), Application-specific Integrated Circuits (ASICs), Application-specific Standard Products (ASSPs), System-on-a-chip systems (SOCs), Complex Programmable Logic Devices (CPLDs), etc. Additionally, although functionality is described herein with regards to specific components/modules shown in example system 100, it is contemplated that in some aspects, functionality of these components/modules can be shared or distributed.

The condition tree structure component 112 determines an abstract syntax tree based on condition statements from code-based content using any known technique, such as any known natural language processing technique. The condition tree structure component 112 determines the attributes of the condition branches from the abstract syntax tree using any known technique, such as any known natural language processing technique. For example, the condition tree structure component 112 analyzes the logical structure of the code-based content to identify the different paths that the execution of the program can take based on certain conditions in order to generate the abstract syntax tree. Using the conditions of the code-based content, the condition tree structure component 112 determines the required attributes of each of the condition branches of the AST. For instance, if the code-based content includes the conditions corresponding to “if the customer's age is above 30, show product A; otherwise, show product B,” the condition tree structure component 112 will analyze the code to identify the branches of the conditions corresponding to the different age groups (e.g., above age 30 and age 30 and below) and the required attribute corresponding to the customer's age.

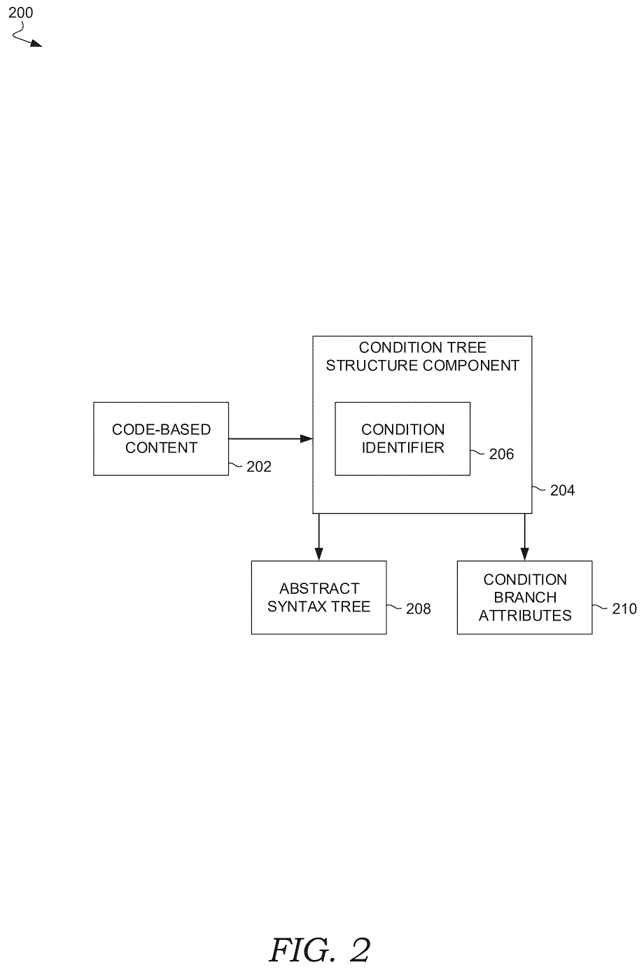

FIG. 2 is a block diagram 200 illustrating an example subsystem for determining an abstract syntax tree of condition branches and condition branch attributes, in accordance with some implementations of the present disclosure. In some configurations, code-based content 202 is received from a user device such as user device 102 by a condition component 204 (e.g., condition tree structure component 112). In some configurations, the code-based content 202 is provided to a condition identifier 206, which performs one or more operations by applying natural language processing techniques to determine abstract syntax tree 208 and the condition branch attributes 210 of the abstract syntax tree 208.

With reference again to FIG. 1, the profile sampling component 114 accesses profiles of a selected target audience from profile schema data 124. Profile schema data 124 includes customer profiles for a particular organization. For example, profile schema data 124 corresponds to a repository of customer profiles, including a wide array of attributes that can be used to rendering personalized content. For instance, profile schema data 124 includes demographic information, behavioral patterns, purchase history, and other relevant details that can be used to personalize content for customers. In various embodiments, the target audience can correspond to a selection of profiles from profile schema data 124. For example, the target audience may correspond to all of the profiles of the profile schema data 124 for the particular organization or a selection of a particular subset profiles, such as profiles corresponding to a particular country or profiles that purchased a particular product.

In various embodiments, the profile sampling component 114 obtains the total number of profiles from profile schema data 124. In various embodiments, the profile sampling component 114 uses any known sampling algorithm to obtain a (e.g., randomized) sampling of profiles from the profile schema data. In various embodiments, the profile sampling component 114 assigns weights to profiles during sampling to account for variations in profile attributes. For example, if the majority of profiles are female, the component assigns weights to male profiles (e.g., higher or lower weights relative female profiles) to ensure they are adequately represented in the sample. In various embodiments, the profile sampling component 114 filters profiles to only include profiles with attributes from the AST (e.g., as determined by condition tree structure component 112). In this regard, by filtering out profiles that do not include attributes from the AST, the profile sampling component 114 reduces the number of profiles compiled by tree evaluation state component 116. In various embodiments, as the backend thread is running, the profile sampling component 114 increases the number of samples to increase the accuracy of the estimated reach of each content variation (e.g., as determined by content variation reach estimation component 118).

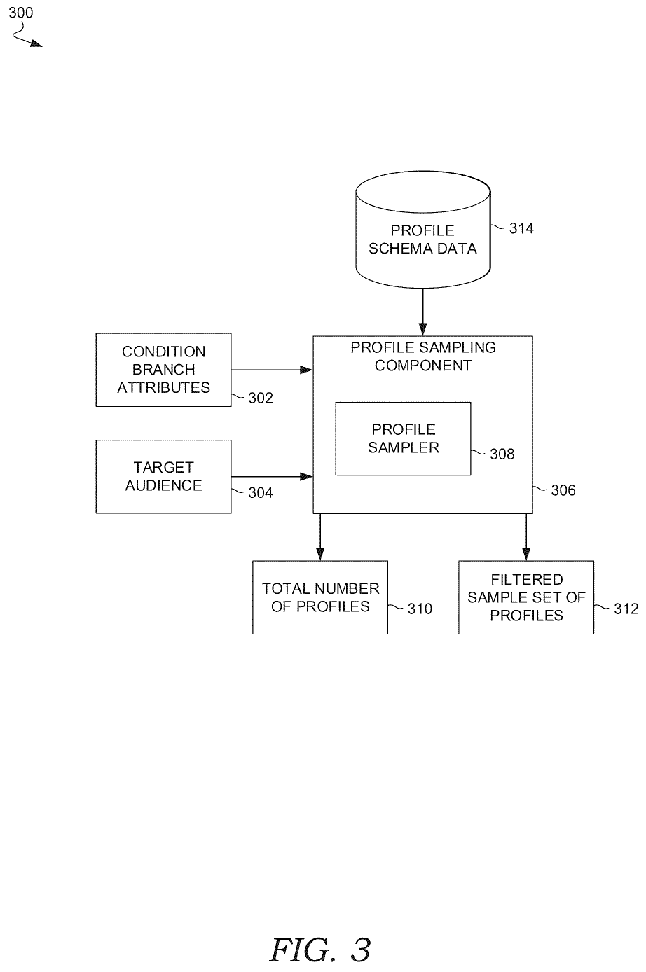

FIG. 3 is a block diagram 300 illustrating an example subsystem for sampling profiles, in accordance with some implementations of the present disclosure. In some configurations, a target audience 304 from profile schema data 314 (e.g., profile schema data 124) is received from a user device such as user device 102 and/or condition branch attributes 302 (e.g., condition branch attributes 210) are received by a profile sampling component 306 (e.g., profile sampling component 114). In some configurations, the target audience 304 from the profile schema data 314 is provided to a profile sampler 308, which performs one or more operations to determine a total number of profiles 310 of the target audience 304. In some configurations, the target audience 304 from the profile schema data 314 and/or condition branch attributes 302 are provided to a profile sampler 308, which performs one or more operations using any known sampling technique to determine a filtered sampled set of profiles 312 that are filtered based on the condition branch attributes 302.

With reference again to FIG. 1, the tree evaluation state component 116 determines the number of profiles per content variation by evaluating the tree evaluation state of each profile (e.g., the sampled and/or filtered set of profiles from profile sampling component 114) using the abstract syntax tree. In various embodiments, the tree evaluation state component 116 is a modified compiler (e.g., Handlebars) that determines the number of profiles per content variation by evaluating the tree evaluation state of each profile without compiling the content variation for each profile or rendering the content variation for each profile, thereby enhancing computational and network efficiency. For example, for each profile of the sampled and/or filtered set of profiles from profile sampling component 114, the tree evaluation state component 116 evaluates the AST to identify the specific conditional paths that each profile follows to determine the tree evaluation state for each profile and stores the tree evaluation state for each profile.

For example, an AST for a particular code-based content includes three condition branches, where one condition branch corresponds to whether the profile has a name, one condition branch corresponds to whether the profile includes a female gender, and one condition branch corresponds to whether the profile includes a male gender. In this regard, if a profile includes a name, the first condition would be true and assigned a value of 1. If a profile does not have a name, the first condition would be false and assigned a value of 0. If a profile includes a female gender, the second condition would be true and assigned a value of 1. If a profile does not include a female gender, the second condition would be false and assigned a value of 0. If a profile includes a male gender, the third condition would be true and assigned a value of 1. If a profile does not include a male gender, the third condition would be false and assigned a value of 0. For a profile, with a name and female gender, the tree evaluation state can be described as [1, 1, 0]. For a profile, without a name or a gender, the tree evaluation state can be described as [0, 0, 0]. As can be understood, each unique tree evaluation state corresponds to a different content variation.

In this regard, the number of profiles per each unique tree evaluation state corresponds to the number of profiles per content variation. The number of profiles per each unique tree evaluation state based on the sampled and/or filtered set of profiles from profile sampling component 114 can be used by content variation reach estimation component 118 to estimate the total number of profiles per content variation for the target audience.

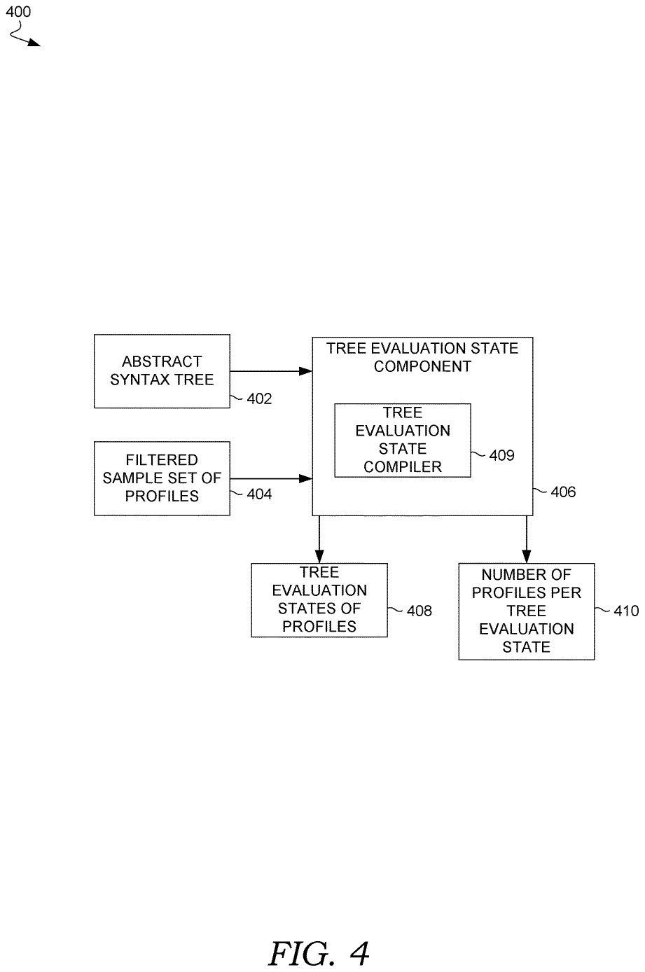

FIG. 4 is a block diagram 400 illustrating an example subsystem for compiling the tree evaluation state of profiles, in accordance with some implementations of the present disclosure. In some configurations, abstract syntax tree 402 (e.g., abstract syntax tree 208) and filtered sample set of profiles 404 (e.g., filtered sample set of profiles 312) is received by a tree evaluation state component 406 (e.g., tree evaluation state component 116). In some configurations, the abstract syntax tree 402 and filtered sample set of profiles 404 are provided to tree evaluation state compiling component 408, which performs one or more operations determine the tree evaluation state of each profile of the filtered sample set of profiles 404 using the abstract syntax tree 402. In some configurations, the abstract syntax tree 402 and filtered sample set of profiles 404 are provided to tree evaluation state compiling component 408, which performs one or more operations determine the number of profiles per tree evaluation state 410 that correspond to the number of profiles of the filtered sample set of profiles 404 per content variation.

With reference again to FIG. 1, the content variation reach estimation component 118 determines the estimated reach of each content variation based on the estimated total number of profiles per content variation. In various embodiments, the content variation reach estimation component 118 determines the estimated total number of profiles per content variation based on the number of profiles per content variation (e.g., each unique tree evaluation state) from tree evaluation state component 116 and the total number of profiles and/or the sampling parameters (e.g., weights assigned to sampled profiles) from profile sampling component 114. The estimated reach of each content variation can be represented as a percentage of profiles that the particular content variation will reach, a total number of profiles that the particular content variation will reach, and/or the like. In various embodiments, the content variation reach estimation component 118 utilizes any known estimation technique to determine the estimated reach of each content variation. In various embodiments, the content variation reach estimation component 118 utilizes the Horvitz-Thompson estimator technique to determine the estimated reach of each content variation. For example, for each content variation, the content variation reach estimation component 118 determines the estimated reach of each content variation using the following example formula:

$$Estimated Reach = ( \frac{Sum of weight of Profiles of a Variation )}{Total profile weight} ) \times Total Profile Count$$

In this regard, the formula estimates the total number of profiles that will follow each condition path and receive the corresponding content variation for the target audience, thereby providing marketers with insights with respect to the estimated reach of each content variation.

In various embodiments, the content variation reach estimation component 118 continuously updates the estimated total number of profiles per content variation to output progressive results by increasing the sample size sampled by profile sampling component 114 and evaluated by tree evaluation state component 116 until final results are reached. In various embodiments, a user can indicate the parameters for the progressive results via the UI component 122, such as by setting the sample size and/or total processing time, to determine when the final results are achieved.

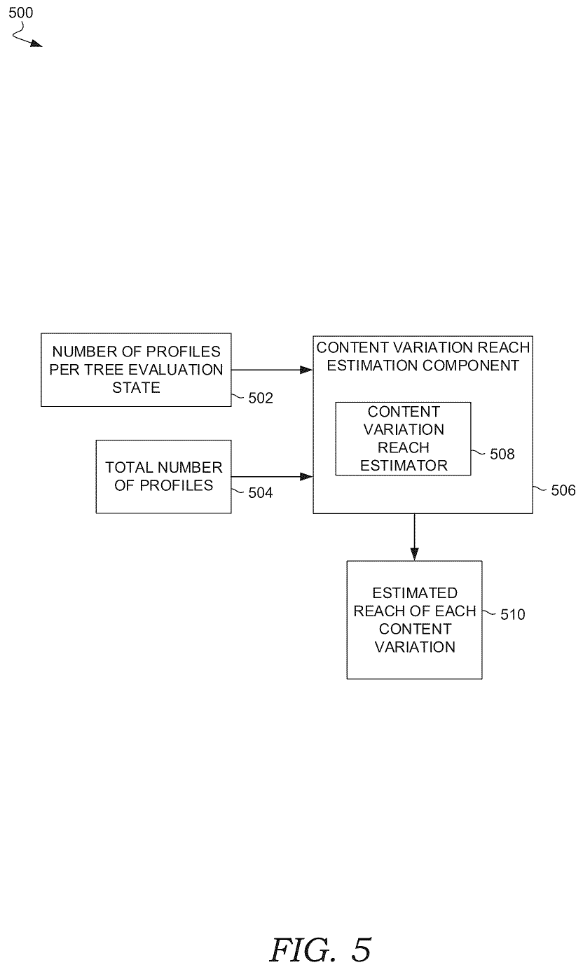

FIG. 5 is a block diagram 500 illustrating an example subsystem for estimating the reach of content variations, in accordance with some implementations of the present disclosure. In some configurations, the number of profiles per tree evaluation state 502 (e.g., number of profiles per tree evaluation state 410) and the total number of profiles 504 (e.g., total number of profiles 310) are received by a content variation reach estimation component 506 (e.g., content variation reach estimation component 118). In some configurations, the number of profiles per tree evaluation state 502 and the total number of profiles 504 are provided to a content variation reach estimator 508, which performs one or more operations by estimation techniques, such as the Horvitz-Thompson estimator technique, to determine an estimated reach of each content variation 510. In various embodiments, the estimated reach of each content variation 510 can be represented as a percentage of profiles that the particular content variation will reach, a total number of profiles that the particular content variation will reach, and/or the like.

With reference again to FIG. 1, the representative content variation component 120 determines representative content variations corresponding to each unique tree evaluation state based on a representative profile for the representative content variation in order to render the render each representative content variation via the UI component 122. In various embodiments, the representative content variation component 120 determines whether the representative content variations have any sensitive data in order to mask the sensitive data when displaying the representative content variations. For example, the representative content variation component 120 detects any attributes within the representative profiles that have labels indicating sensitive information, such as data usage labels indicating personally identifiable information (PII). The representative content variation component 120 automatically masks attributes detected as sensitive to ensure that sensitive data is protected during the rendering and reviewing process. Once the representative content variations are determined and sensitive data is masked, the representative content variation component 120 causes the UI component 122 to render the representative content variations to provide a visual representation how each content variation will appear to the user.

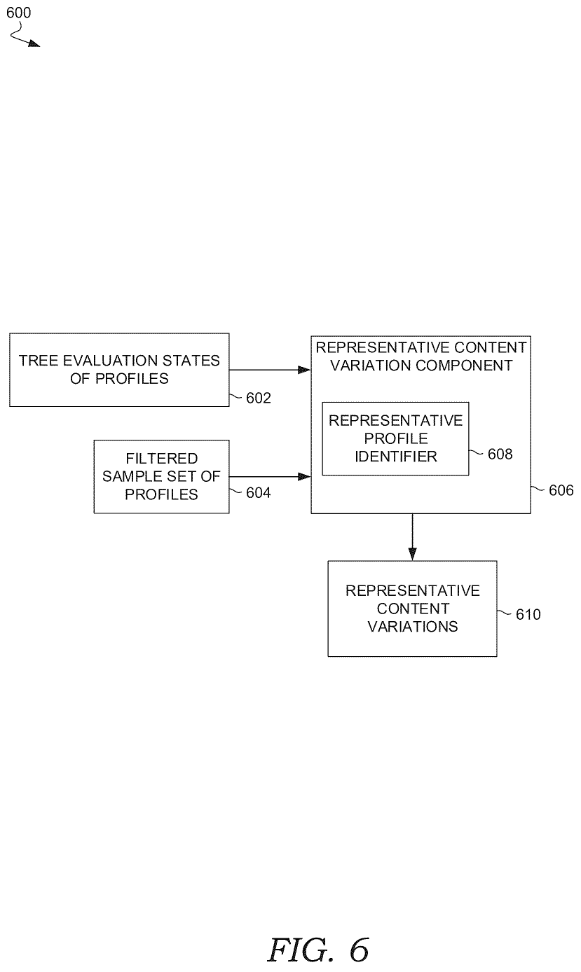

FIG. 6 is a block diagram 600 illustrating an example subsystem for causing rendering of a representative content variations, in accordance with some implementations of the present disclosure. In some configurations, each of the unique tree evaluation states of profiles 602 (e.g., tree evaluation states of profiles 408) corresponding to each of the unique content variations and the filtered sample set of profiles 604 (e.g., filtered sample set of profiles 312) are received by representative content variation component 606 (e.g., representative content variation component 120). In some configurations, each of the unique tree evaluation states of profiles 602 and the filtered sample set of profiles 604 are provided to a representative profile identifier 608, which performs one or more operations to determine a representative profile in order to cause rendering of rendering content variations 610 corresponding to each unique tree evaluation state.

Turning again to FIG. 1, the content reach estimation and review system 104 further includes a user interface component 122 that provides one or more user interfaces for users to interact with the content reach estimation and review system 104. For instance, the user interface component 122 provides one or more user interfaces to user devices, such as the user device 102. In some instances, the user interfaces can be presented on the user device 102 via the application 108, which can be a web browser or a dedicated application for interacting with the content reach estimation and review system 104. Among other things, the user interface component 122 can provide user interfaces for interacting with the content reach estimation and review system 104 to facilitate display of the progressive results, the abstract syntax tree, and/or the representative rendered content variations. For instance, the user interface component 122 can provide user interfaces enabling users to provide code-based content and a selection of customer profiles (e.g., profile schema data 124). The user interface component 122 can also provide user interfaces to cause display of the progressive results to dynamically update the estimated total number of profiles per content variation from the backend thread. The user interface component 122 can also provide user interfaces to cause display of the AST, condition branches of the AST, and/or the unique tree evaluation states of the AST to allow users to understand the conditional paths and branching logic of each of the content variations. The user interface component 122 can also provide user interfaces to cause display of the representative content variations, ensuring that sensitive data is masked while still providing a comprehensive view of the content variations for reviewing of each of the content variations.

### Example Methods for Estimating Content Reach and Reviewing Personalized Content

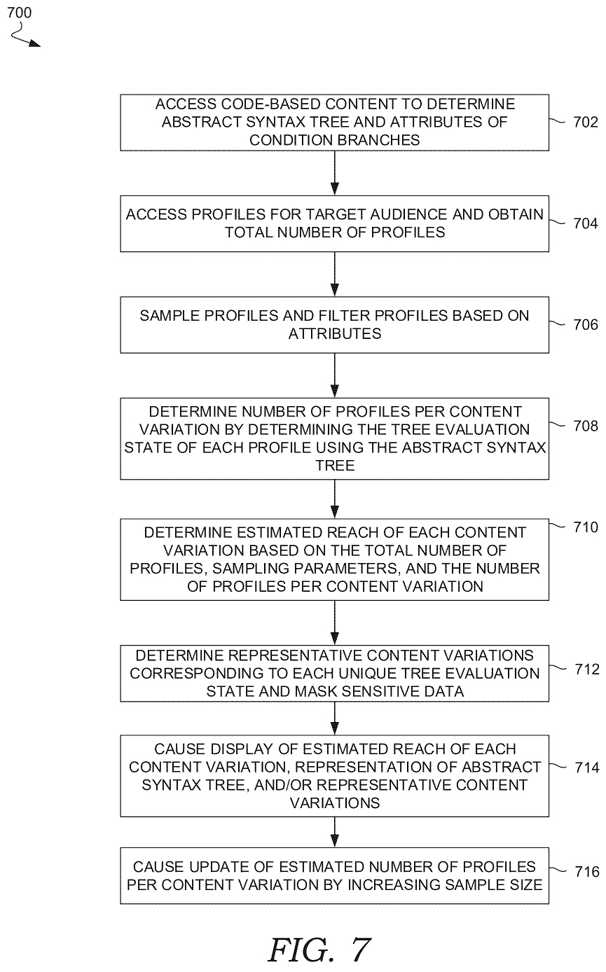

With reference now to FIG. 7, a flow diagram is provided that illustrates a method 700 for estimating content reach and reviewing personalized content. The method 700 can be performed, for instance, by content reach estimation and review system 104 in FIG. 1. Each block of the method 700 and any other methods described herein comprises a computing process performed using any combination of hardware, firmware, and/or software. For instance, various functions can be carried out by a processor executing instructions stored in memory. The methods can also be embodied as computer-usable instructions stored on computer storage media. The methods can be provided by a standalone application, a service or hosted service (standalone or in combination with another hosted service), or a plug-in to another product, to name a few.

At block 702, code-based content is accessed to determine the AST and attributes of condition branches of the AST. For example, the logical structure of the code-based content, such as condition statements of an HTML email, is analyzed to identify the different paths that the execution of the program can take based on certain condition in content. In various embodiments, natural language processing techniques are applied to generate the AST and determine the required attributes of each condition branch. For example, if the code-based content includes conditions corresponding to “if the customer's age is above 30, show product A; otherwise, show product B,” the condition tree structure component will analyze the code to identify the branches of the conditions corresponding to the different age groups and the required attribute corresponding to the customer's age.

At block 704, profiles for the target audience are accessed and the total number of profiles of the target audience is obtained. For example, profiles are retrieved from the profile schema data, which includes demographic information, behavioral patterns, purchase history, and other relevant details from customer profiles. The target audience may correspond to all profiles in the profile schema data or a selection of a particular subset of profiles, such as profiles corresponding to a specific country or profiles that purchased a particular product.

At block 706, the target set of profiles are sampled and the sampled set of profiles are filtered to only include profiles with attributes of the condition branches of the AST. For example, any known sampling algorithm can be used to obtain a representative selection of profiles. In various embodiments, the sampling algorithm uses weighted sampling to assign weights to profiles during sampling to account for variations in profile attributes. In various embodiments, profiles are filtered to include only those with the required attributes from the AST, thereby reducing the number of profiles that are compiled to determine the corresponding tree evaluation state of each profile. By reducing the number of profiles, in certain embodiments, computational and network efficiency can be enhanced by focusing only on the profiles that are relevant to the conditions identified in the code-based content.

At block 708, the number of profiles per content variation is determined by evaluating the tree evaluation state of each profile based on the AST. For example, the tree evaluation state of each profile is compiled with respect to the AST by a modified compiler to identify the specific conditional paths that each profile follows without compiling or rendering the content for each profile, thereby enhancing efficiency. The tree evaluation state of each profile is then stored. Each unique tree evaluation state corresponds to a different content variation, and the number of profiles per each unique tree evaluation state corresponds to the number of profiles per content variation for the sample set of profiles, which can be used to estimate the total number of profiles per content variation for the target set of profiles.

At block 710, the estimated reach of each content variation is determined based on the total number of profiles, sampling parameters, and/or the number of profiles per content variation. The estimated reach of each content variation using any known estimation techniques, such as a Horvitz-Thompson estimator, to calculate the estimated reach for each content variation to the target audience. For instance, the estimated reach of each content variation can provide insights into how the different content variations of the code-based content will be distributed across the audience segment. In various embodiments, the estimated total number of profiles per content variation is continuously updated via a background thread to output progressive results, allowing for real-time refinement of the estimation process while providing the progressive results to the user in parallel.

At block 712, representative content variations corresponding to each unique tree evaluation state are determined and sensitive data in the representative content variations is masked. For example, representative profiles are determined for each unique tree evaluation state in order to render representative content variations to allow the user to review the representative content variations. By only rendering representative content variations instead of requiring the user to manually render the content variations or render the content variations for a larger amount of profiles, computational and network efficiency is enhanced. In various embodiments, sensitive data is detected and masked to ensure privacy during review by the user. In this regard, once the representative content variations are determined and sensitive data is masked, the UI component renders the representative content variations, thereby providing a visual representation of how the content will appear to different audience segments.

At block 714, the estimated reach of each content variation, a representation of the AST, and/or representative content variations are displayed to the user for review. For example, the user can review the estimated reach of each content variation to ensure that the content variation reach the intended audience segments. The user can review conditions of the code-based content using the representation of the AST to ensure that the conditions are correct. The user can review the representative content variations to ensure that the visual representation of each content variation is correct. In various embodiments, the estimated reach of each content variation, a representation of the AST, and/or representative content variations are displayed to the user in parallel with the background thread refining the progressive results corresponding to the estimated reach of each content variation.

At block 716, the estimated number of profiles per content variation is updated (e.g., refined) by increasing the sample size. For example, the number of samples are increased to refine the estimation results, ensuring that the personalized content reaches the intended audience segments. In various embodiments, the estimated reach of each content variation is refined via a background thread in parallel with displaying the prior estimated reach of each content variation to the user. The continuous refinement of the estimation process ensures that marketers have initial insights regarding the distribution of each content variation to the target profiles while continuing to refine the insights in parallel, thereby improving computational and network efficiency and the user experience.

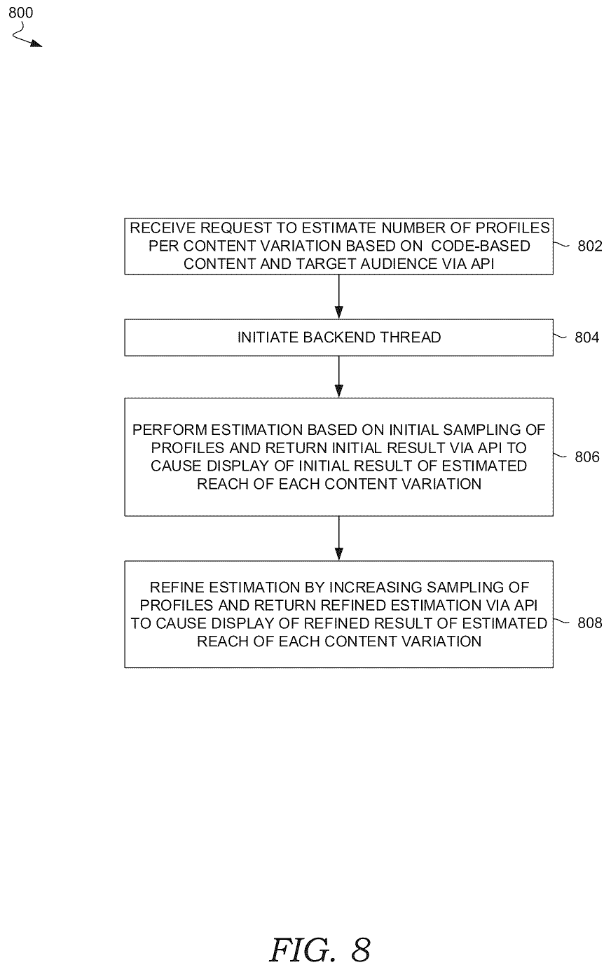

With reference now to FIG. 8, a flow diagram is provided that illustrates a method 800 for initiating a backend thread to estimate content reach. The method 800 can be performed, for instance, by content reach estimation and review system 104 in FIG. 1. Each block of the method 800 and any other methods described herein comprises a computing process performed using any combination of hardware, firmware, and/or software. For instance, various functions can be carried out by a processor executing instructions stored in memory. The methods can also be embodied as computer-usable instructions stored on computer storage media. The methods can be provided by a standalone application, a service or hosted service (standalone or in combination with another hosted service), or a plug-in to another product, to name a few.

At block 802, a request is received from a user via an API to estimate the number of profiles per content variation based on input code-based content and a selected target audience. For example, the code-based content, such as HTML email, can includes personalization elements such as conditions, images, links, tables, and styled text. The target audience can be selected from profile schema data, which includes demographic information, behavioral patterns, purchase history, and other relevant details of customer profiles. In various embodiments, the API facilitates communication between the user device and the content reach estimation and review system, ensuring that the request is processed efficiently and accurately.

At block 804, a backend thread is initiated to perform the estimation process. This backend thread runs in parallel with the main thread that displays progressive results to the user via the API, thereby allowing for concurrent execution of tasks, such as data processing, handling network requests and performing complex calculations, to refine progressive results. By running the estimation process as a background thread, the system can provide real-time feedback and progressively improve the accuracy of its estimations while reducing to latency to provide initial estimations to the user.

At block 806, the backend thread performs the initial estimation based on the initial sampling of profiles and returns the initial result via the API to cause the display of the initial estimated reach of each content variation. For example, an initial sample set of profiles are analyzed to determine the number of profiles per content variation based on the tree evaluation state of each profile with respect to an AST determined from the code-based content. The initial estimation provides a preliminary estimate of the reach of each content variation, allowing the user to review and verify the content variations would reach the intended audience segments.

At block 808, the backend thread refines the estimation by increasing the sampling of profiles and returns the refined estimation via the API to cause the display of the refined estimated reach of each content variation. For example, a larger sample set of profiles (e.g., an initial sample of 100 profiles, a refined estimation based on a larger sample of 1,000 profiles, a further refined estimation based on an even larger sample of 10,000 profiles, etc.) are analyzed to determine the number of profiles per content variation based on the tree evaluation state of each profile with respect to the AST determined from the code-based content. The refined estimation provides a more accurate estimate of the reach of each content variation, allowing the user to review and verify the content variations would reach the intended audience segments. The continuous refinement of the estimation process ensures that marketers have initial insights regarding the distribution of each content variation to the target profiles while continuing to refine the insights in parallel until a final result is reached, thereby improving computational and network efficiency and the user experience.

### Exemplary Operating Environment

Having described implementations of the present disclosure, an exemplary operating environment in which embodiments of the present technology may be implemented is described below in order to provide a general context for various aspects of the present disclosure. Referring initially to FIG. 9 in particular, an exemplary operating environment for implementing embodiments of the present technology is shown and designated generally as computing device 900. Computing device 900 is but one example of a suitable computing environment and is not intended to suggest any limitation as to the scope of use or functionality of the technology. Neither should the computing device 900 be interpreted as having any dependency or requirement relating to any one or combination of components illustrated.

The technology may be described in the general context of computer code or machine-useable instructions, including computer-executable instructions such as program modules, being executed by a computer or other machine, such as a personal data assistant or other handheld device. Generally, program modules including routines, programs, objects, components, data structures, etc., refer to code that perform particular tasks or implement particular abstract data types. The technology may be practiced in a variety of system configurations, including hand-held devices, consumer electronics, general-purpose computers, more specialty computing devices, etc. The technology may also be practiced in distributed computing environments where tasks are performed by remote-processing devices that are linked through a communications network.

With reference to FIG. 9, computing device 900 includes bus 910 that directly or indirectly couples the following devices: memory 912, one or more processors 914, one or more presentation components 916, input/output (I/O) ports 918, input/output components 920, and illustrative power supply 922. Bus 910 represents what may be one or more busses (such as an address bus, data bus, or combination thereof). Although the various blocks of FIG. 9 are shown with lines for the sake of clarity, in reality, delineating various components is not so clear, and metaphorically, the lines would more accurately be grey and fuzzy. For example, one may consider a presentation component such as a display device to be an I/O component. Also, processors have memory. The inventors recognize that such is the nature of the art, and reiterate that the diagram of FIG. 9 is merely illustrative of an exemplary computing device that can be used in connection with one or more embodiments of the present technology. Distinction is not made between such categories as “workstation,” “server,” “laptop,” “hand-held device,” etc., as all are contemplated within the scope of FIG. 9 and reference to “computing device.”

Computing device 900 typically includes a variety of computer-readable media. Computer-readable media can be any available media that can be accessed by computing device 900 and includes both volatile and nonvolatile media, removable and non-removable media. By way of example, and not limitation, computer-readable media may comprise computer storage media and communication media. Computer storage media includes both volatile and nonvolatile, removable and non-removable media implemented in any method or technology for storage of information such as computer-readable instructions, data structures, program modules or other data.

Computer storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can be accessed by computing device 900. The terms “computer storage media” and “computer storage medium” do not comprise signals per se.

Communication media typically embodies computer-readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of any of the above should also be included within the scope of computer-readable media.

Memory 912 includes computer storage media in the form of volatile and/or nonvolatile memory. The memory may be removable, non-removable, or a combination thereof. Exemplary hardware devices include solid-state memory, hard drives, optical-disc drives, etc. Computing device 900 includes one or more processors that read data from various entities such as memory 912 or I/O components 920. Presentation component(s) 916 present data indications to a user or other device. Exemplary presentation components include a display device, speaker, printing component, vibrating component, etc.

I/O ports 918 allow computing device 900 to be logically coupled to other devices including I/O components 920, some of which may be built in. Illustrative components include a microphone, joystick, game pad, satellite dish, scanner, printer, wireless device, etc. The I/O components 920 may provide a natural user interface (NUI) that processes air gestures, voice, or other physiological inputs generated by a user. In some instance, inputs may be transmitted to an appropriate network element for further processing. A NUI may implement any combination of speech recognition, touch and stylus recognition, facial recognition, biometric recognition, gesture recognition both on screen and adjacent to the screen, air gestures, head and eye-tracking, and touch recognition associated with displays on the computing device 900. The computing device 900 may be equipped with depth cameras, such as, stereoscopic camera systems, infrared camera systems, RGB camera systems, and combinations of these for gesture detection and recognition. Additionally, the computing device 900 may be equipped with accelerometers or gyroscopes that enable detection of motion.

The present technology has been described in relation to particular embodiments, which are intended in all respects to be illustrative rather than restrictive. Alternative embodiments will become apparent to those of ordinary skill in the art to which the present technology pertains without departing from its scope.

Having identified various components utilized herein, it should be understood that any number of components and arrangements may be employed to achieve the desired functionality within the scope of the present disclosure. For example, the components in the embodiments depicted in the figures are shown with lines for the sake of conceptual clarity. Other arrangements of these and other components may also be implemented. For example, although some components are depicted as single components, many of the elements described herein may be implemented as discrete or distributed components or in conjunction with other components, and in any suitable combination and location. Some elements may be omitted altogether. Moreover, various functions described herein as being performed by one or more entities may be carried out by hardware, firmware, and/or software, as described below. For instance, various functions may be carried out by a processor executing instructions stored in memory. As such, other arrangements and elements (e.g., machines, interfaces, functions, orders, and groupings of functions) can be used in addition to or instead of those shown.

Embodiments described herein may be combined with one or more of the specifically described alternatives. In particular, an embodiment that is claimed may contain a reference, in the alternative, to more than one other embodiment. The embodiment that is claimed may specify a further limitation of the subject matter claimed.

The subject matter of embodiments of the technology is described with specificity herein to meet statutory requirements. However, the description itself is not intended to limit the scope of this patent. Rather, the inventors have contemplated that the claimed subject matter might also be embodied in other ways, to include different steps or combinations of steps similar to the ones described in this document, in conjunction with other present or future technologies. Moreover, although the terms “step” and/or “block” may be used herein to connote different elements of methods employed, the terms should not be interpreted as implying any particular order among or between various steps herein disclosed unless and except when the order of individual steps is explicitly described.

For purposes of this disclosure, the word “including” has the same broad meaning as the word “comprising,” and the word “accessing” comprises “receiving,” “referencing,” or “retrieving.” Further, the word “communicating” has the same broad meaning as the word “receiving,” or “transmitting” facilitated by software or hardware-based buses, receivers, or transmitters using communication media described herein. In addition, words such as “a” and “an,” unless otherwise indicated to the contrary, include the plural as well as the singular. Thus, for example, the constraint of “a feature” is satisfied where one or more features are present. Also, unless indicated otherwise, the term “or” includes the conjunctive, the disjunctive, and both (a or b thus includes either a or b, as well as a and b). Further, the term “and/or” includes the conjunctive, the disjunctive, and both (a and/or b thus includes either a or b, as well as a and b).

For purposes of a detailed discussion above, embodiments of the present technology are described with reference to a distributed computing environment; however, the distributed computing environment depicted herein is merely exemplary. Components can be configured for performing novel embodiments of embodiments, where the term “configured for” can refer to “programmed to” perform particular tasks or implement particular abstract data types using code. Further, while embodiments of the present technology may generally refer to the technical solution environment and the schematics described herein, it is understood that the techniques described may be extended to other implementation contexts.

From the foregoing, it will be seen that this technology is one well adapted to attain all the ends and objects set forth above, together with other advantages which are obvious and inherent to the system and method. It will be understood that certain features and subcombinations are of utility and may be employed without reference to other features and subcombinations. This is contemplated by and is within the scope of the claims.

1. One or more computer storage media storing computer-useable instructions that, when used by one or more computing devices, cause the one or more computing devices to perform operations, the operations comprising:
determining an abstract syntax tree (AST) from code-based content by processing condition statements of the code-based content such that nodes of the AST represent the condition statements and edges of the AST define condition branches representing execution paths of the code-based content based on outcomes of the condition statements;
determining a sample set of profiles by sampling a target set of profiles;
determining a number of profiles per content variation by:
compiling a corresponding tree evaluation state of each profile of the sample set of profiles with respect to the AST, wherein the corresponding tree evaluation state of each profile comprises a set of values, each value of the set of values being a true or false value for each of the condition branches after evaluating the profile against the condition statements; and
determining the number of profiles per content variation based on a corresponding number of profiles per tree evaluation state;
determining an estimated reach of each content variation based on the number of profiles per content variation and a total number of profiles of the target set of profiles; and
causing display of the estimated reach of each content variation.

2. The one or more computer storage media of claim 1, wherein causing display of the estimated reach of each content variation further comprises:
causing display of progressive results corresponding to the estimated reach of each content variation by initiating a background thread to refine the estimated reach of each content variation by increasing a sample size when sampling the target set of profiles.

3. The one or more computer storage media of claim 1, the operations further comprising:
determining a representative content variation for each content variation based on a corresponding representative profile from the sample set of profiles;
masking sensitive data from the representative content variation; and
causing display of the representative content variation for each content variation.

4. The one or more computer storage media of claim 1, the operations further comprising:
determining attributes of the condition branches of the abstract syntax tree; and
filtering the sample set of profiles to only include profiles that include the attributes.

5. The one or more computer storage media of claim 1, the operations further comprising:
applying weights to the sample set of profiles based on attributes of the target set of profiles; and
estimating the estimated reach of each content variation based on the weights.

6. The one or more computer storage media of claim 1, wherein determining the estimated reach of each content variation further comprises:
determining the estimated reach of each content variation using a Horvitz-Thompson estimator.

7. The one or more computer storage media of claim 1, wherein each content variation corresponds to a unique tree evaluation state.

8. The one or more computer storage media of claim 1, wherein the code-based content corresponds to HyperText Markup Language (HTML) electronic mail (email).

9. A computer-implemented method comprising:
causing display of progressive results estimating reach of content variations of code-based content to a target set of profiles by causing a background thread to:
determine an abstract syntax tree (AST) from the code-based content by processing condition statements of the code-based content such that nodes of the AST represent the condition statements and edges of the AST define condition branches representing execution paths of the code-based content based on outcomes of the condition statements;
determine a sample set of profiles by sampling the target set of profiles;
determine a number of profiles per content variation by:
compiling a corresponding tree evaluation state of each profile of the sample set of profiles with respect to the AST, wherein the corresponding tree evaluation state of each profile comprises a set of values, each value of the set of values being a true or false value for each of the condition branches after evaluating the profile against the condition statements; and
determining the number of profiles per content variation based on a corresponding number of profiles per tree evaluation state;
determine an estimated reach of each content variation based on the number of profiles per content variation and a total number of profiles of the target set of profiles, by compiling the corresponding tree evaluation state of each profile of the sample set of profiles while refraining from compiling or rendering the code-based content for the sample set of profiles to determine the estimated reach; and
refine the estimated reach of each content variation by increasing a sample size when sampling the target set of profiles.

10. The computer-implemented method of claim 9, further comprising:
causing display of the progressive results in parallel with running the background thread to refine the estimated reach of each content variation.

11. The computer-implemented method of claim 9, further comprising:
determining a representative content variation for each content variation based on a corresponding representative profile from the sample set of profiles;
masking sensitive data from the representative content variation; and
causing display of the representative content variation for each content variation.

12. The computer-implemented method of claim 9, further comprising:
determining attributes of the condition branches of the abstract syntax tree; and
filtering the sample set of profiles to only include profiles that include the attributes.

13. The computer-implemented method of claim 9, further comprising:
applying weights to the sample set of profiles based on attributes of the target set of profiles; and
estimating the estimated reach of each content variation based on the weights.

14. The computer-implemented method of claim 9, wherein determining the estimated reach of each content variation further comprises:
determining the estimated reach of each content variation using a Horvitz-Thompson estimator.

15. The computer-implemented method of claim 9, wherein each content variation corresponds to a unique tree evaluation state.

16. The computer-implemented method of claim 9, wherein the code-based content corresponds to HyperText Markup Language (HTML) electronic mail (email).

17. A computer system comprising:
one or more processors; and
one or more computer storage media storing computer-useable instructions that, when used by the one or more processors, cause the one or more processors to perform operations, the operations comprising:
accessing a selection of code-based content to determine an abstract syntax tree (AST) from the code-based content by processing condition statements of the code-based content such that nodes of the AST represent the condition statements and edges of the AST define condition branches representing execution paths of the code-based content based on outcomes of the condition statements;
accessing profile schema data to determine a sample set of profiles by sampling the selection of a target set of profiles;
determining a number of profiles per content variation by:
compiling a corresponding tree evaluation state of each profile of the sample set of profiles with respect to the AST, wherein the corresponding tree evaluation state of each profile comprises a set of values, each value of the set of values being a true or false value for each of the condition branches after evaluating the profile against the condition statements; and
determining the number of profiles per content variation based on a corresponding number of profiles per tree evaluation state;
determining an estimated reach of each content variation based on the number of profiles per content variation and a total number of profiles of the target set of profiles; and
causing display of progressive results corresponding to the estimated reach of each content variation by refining the estimated reach of each content variation by increasing a sample size when sampling the target set of profiles.

18. The computer system of claim 17, wherein the operations further comprise:
causing display of the progressive results in parallel with running a background thread to refine the estimated reach of each content variation.

19. The computer system of claim 17, wherein the operations further comprise:
determining a representative content variation for each content variation based on a corresponding representative profile from the sample set of profiles;
masking sensitive data from the representative content variation; and
causing display of the representative content variation for each content variation.

20. The computer system of claim 17, wherein the operations further comprise:
determining attributes of the condition branches of the abstract syntax tree; and
filtering the sample set of profiles to only include profiles that include the attributes.
